(19) United States
(12) Patent Application Publication
(10) Pub. No.: US 2002/0087341 A1
(43) Pub. Date: Jul. 4, 2002

(54) Customer care and billing system

(76) Inventors: Jochen Kappel, Vence (FR); Josef Markgraf, Goldbach (DE); Michael Meadows, Sundbyberg (SE)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 09/819,446

(22) Filed: Mar. 28, 2001

Related U.S. Application Data
(60) Provisional application No. 60/193,422, filed on Mar. 31, 2000.

(30) Foreign Application Priority Data
Mar. 31, 2000 (DE) 00106948.3-2201

(51) Int. Cl. G06F 17/60

(52) U.S. Cl. 705/1; 705/34

(57) ABSTRACT

The present invention relates to a customer care and billing system (1), especially for communication services, comprising at least one database (7) for storage and retrieval of data which is preferably formed as a server. The system (1) comprises at least one application server with accompanying clients that communicates with the database (7), and an appropriate framework (10). Relevant services corresponding to desired customer care or billing processes are offered to the system user. The system (1) comprises a distributed component architecture including components (5) attributed in correspondence to the relevant services offered, wherein the components (5) are able to communicate with each other directly via interfaces.

### CROSS-REFERENCE TO RELATED APPLICATION

This application claims priority to copending U.S. provisional application entitled, “Targys System,” having ser. No. 60/193,422, filed Mar. 31, 2000, which is entirely incorporated herein by reference. This application also claims priority to German Patent Application No. 00106948.3-2201, entitled “Customer Care and Billing System,” filed Mar. 31, 2000, which is entirely incorporated herein by reference.

### DESCRIPTION

The present invention relates to a customer care and billing system, especially for communication services, according to the preamble of claim 1.

Customer care and billing systems are used in all firms that offer any customer goods or services, wherein the amount of consumption of goods or the length of utilisation of services represent the main criteria for the prices that have to be paid by the consumer. In addition, such firms mostly have a large amount of customers (cf. power supply, gas supply, water supply, telecommunications) so that a lot of administration effort is required. Customer care and billing systems facilitate a simple administration of the enormous amount of customer data for such firms calculating the amounts of the bills to be charged relating to appropriate settings fixed in advance, and mostly drawing up the bills themselves.

Customer care and billing systems known in the prior art comprise a central database that especially serves to store application data. Mostly the database is formed as a relational database and simultaneously represents the main server of the system. Via clients, especially via GUIs (Graphic User Interfaces), certain services of the customer care and billing sector are offered to the system user. Additional application servers can be connected inbetween the clients and the database. Every client or every application server, respectively, is connected to the central database where all data necessary for application can be retrieved and altered.

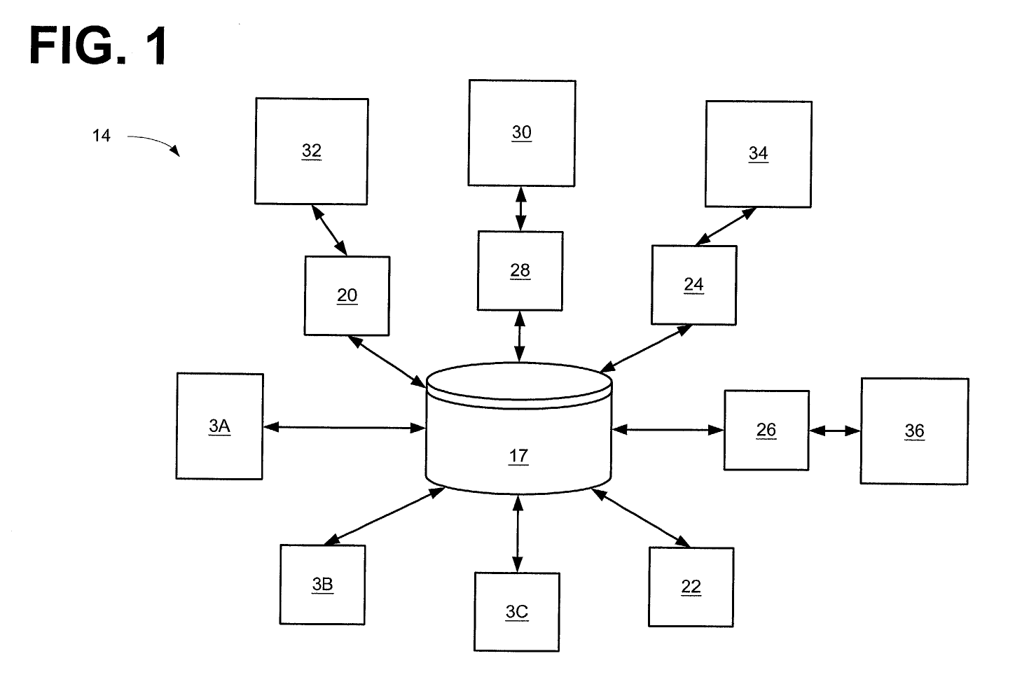

First of all, for a better understanding a typical embodiment of a known customer care and billing system for the mobile telecommunication market is described with reference to FIG. 1. Explaining this example, the processes executed in such a system and the possibilities provided by the system shall be shown in a simplified manner.

The system 14 comprises a central relational database 17 simultaneously representing the main server of the system 14 that is connected to a plurality of modules 3 via network. The modules 3 can be formed as a client or as an application server with accompanying clients, and via GUIs or programming interfaces they provide facilities to the user to enlist customer care or billing services set in advance. The necessary set of data is stored in tables of the central database 17 and can be retrieved there.

Mobile Switching Centres (MSC) 32 determine and store call data like origin, destination, duration and kind of service in a cellular telecommunication network. The informations are read into the customer care and billing system 14 and processed by suited rating modules 20 calculating the fees. The necessary data is retrieved from the central database 17, and the calculated data stored in the database 17 after the rating process. This data can be retrieved by a billing module 22 that helps the provider to generate the bills for the customers. Customer care is also supported by multiple modules which are used for different services. For example, information regarding free resources can be forwarded to a SIM vendor 34 via a module 24. In the same way a provider needs modules 26 to complete transactions regarding banks or invoicing agencies 36 and modules 28 for the transmission of data to a Home Location Register (HLR) 30 of the cellular network where customer data is stored.

Each module 3 is directly connected to the central database 17. However, the modules 3 are not able to communicate with each other directly via interfaces. Interfaces between the modules 3 usually are not explicitly defined at all. Instead, the central database 17 serves as a big implicit interface between the various modules 3 causing a lot of unnecessary internal interdependencies. Thus the interface is represented by a set of database tables. In addition, in such systems 14 the database 17 is mostly formed as a server. Therefore, it is used to configure the business logic in the different modules 3 and does not only serve for storage of data, but even represents the interface to external systems and serves for communication between the modules 3.

In the last years there have been vigorous changes in the telecommunication sector caused by the increasing development of new technologies (mobiles, WAP etc.) As the market is open to any competitor, potential subscribers are courted by many providers with ever increasing intensity. Therefore it is inevitable for the provider to give attention to such changes and rapidly adapt to the requirements of the market. While the number of subscribers and the technological possibilities are increasing the demands on customer care and billing systems are increasing accordingly.

The conventional systems of the prior art have the disadvantage that the code of the corresponding systems has to be modified whenever modifications or extensions occur due to changed demands of the system user. This results in increasing personal costs as well as in a considerable delay regarding the adaptation of the system to the requirements of the market.

It is therefore the object of the present invention to provide a customer care and billing system, especially for communication services, wherein changes or extensions of the system caused by changed demands of the system user can rapidly be carried out causing as little programming effort as possible.

This object is solved by the features of claim 1.

As the system comprises a distributed component architecture including components attributed in correspondence to the relevant services offered, wherein the components are able to communicate with each other directly via interfaces, a flexible configuration of the business logic is facilitated so that customer demands can be fulfilled with a minimum of implementation modifications. Furthermore, the system can flexibly and easily be adapted to an increasing amount of processing data.

Advantageously the system is divided into at least two hierarchically arranged layers with an increasing degree of abstraction. Each layer isolates the above layer from the lower layers so that details of implementation of the lower layers are hidden from the layers above. In the preferred embodiment of the customer care and billing system according to the invention the system is divided into a base layer, a common layer, a technical services layer, an application layer and a business layer.

In particular it is advantageous that the system is divided into at least two hierarchically arranged tiers corresponding to technical tasks. Processes in different logical tiers can be executed simultaneously and independent from each other. Furthermore, a fine-grained division into physical layers is possible. In the preferred embodiment of the customer care and billing system according to the invention the system is divided into a presentation tier, an application tier, a meta-application tier, a domain tier, a persistence tier and a database tier.

The meta-application tier advantageously provides facilities to an application in the system to describe aspects of itself. This allows a dynamic (i.e., executable during processing) configuration of the behaviour of the single component.

Advantageously the system comprises a meta-application dictionary 50 that the programming effort regarding modifications on server side can be held low.

Further advantages result from the fact that the system comprises facilities to make the server's interface model available on client side and thus to hide the employed communication technology from a client developer.

It is advantageous that the system provides defined interfaces and mechanisms for inquiry distribution so that multiple application servers of the same kind can be added to the system. Thus, with little effort the amount of processing data can be enormously increased without reduction of the processing speed.

Advantageously the system provides the possibility of replacing or adding components so that the system will not become obsolete and can offer varied or additional services without exchanging the whole system and without extensive coding. Thus, the production of the upgrades is relatively economical and simple.

The possibility to extend classes and/or to add new classes provides the advantage to be able to vary a component during processing by using meta-application facilities.

Advantageously, division of labour in the system is supported as the database is divided into a plurality of independent database sections and/or as multiple independent databases exist, wherein each of the independent database sections and/or the independent databases only communicate with one component.

Advantageously the system provides mechanisms to allow transaction and memory management distributed over components so that robustness and reliability of the system are guaranteed.

Further details, features and advantages of the invention result from the following description with reference to the drawings, in which:

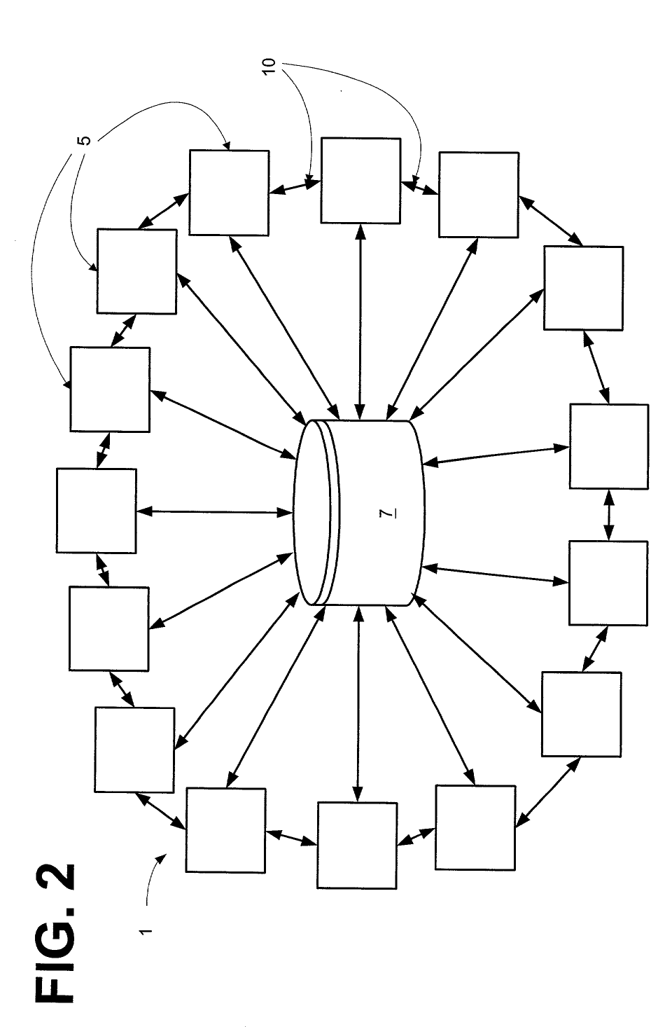

FIG. 2 shows a schematic view of composition of an embodiment of the customer care and billing system according to the invention;

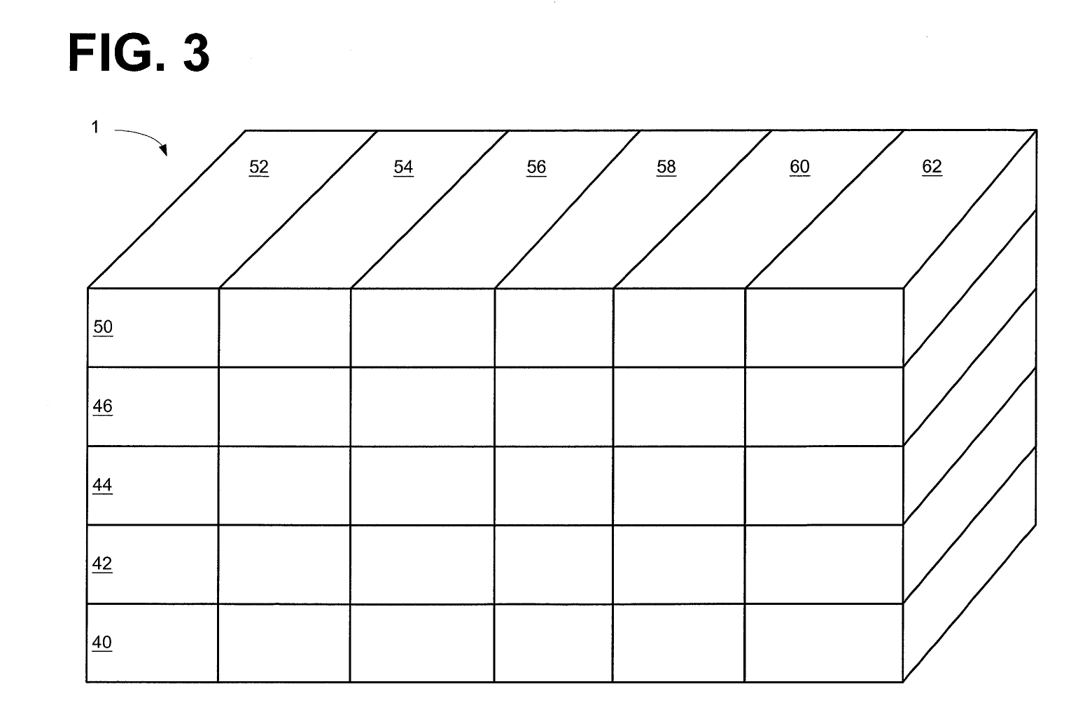

FIG. 3 shows a schematic view of the internal architecture of a preferred embodiment of the customer care and billing system according to the invention, wherein the system is divided into layers with an increasing degree of abstraction and into tiers corresponding to the technical tasks;

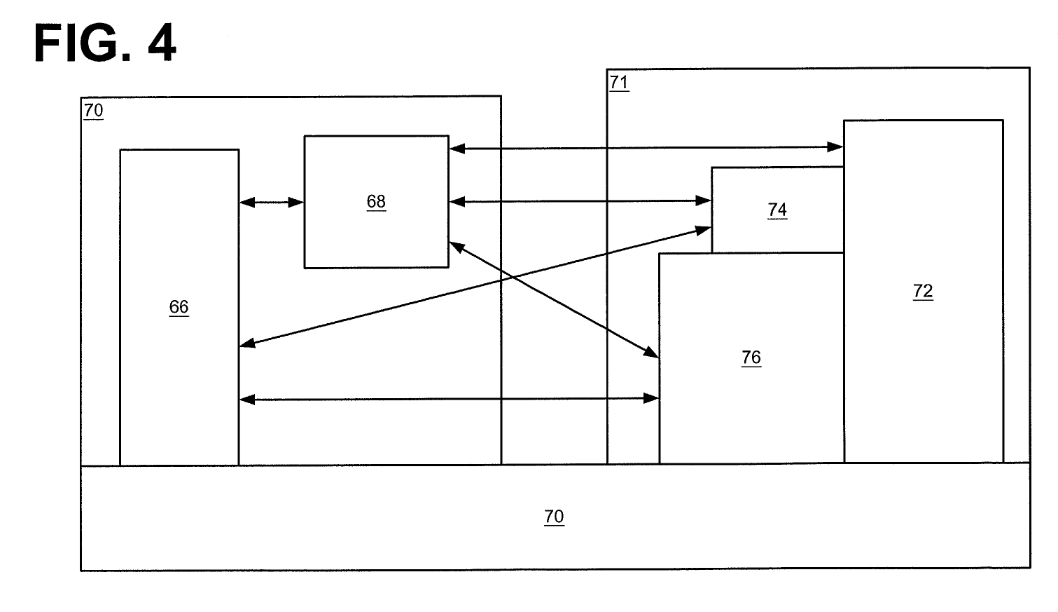

FIG. 4 shows a schematic view of the possibilities of communication between servers and clients in the preferred embodiment of the customer care and billing system according to the invention shown in FIG. 3; and

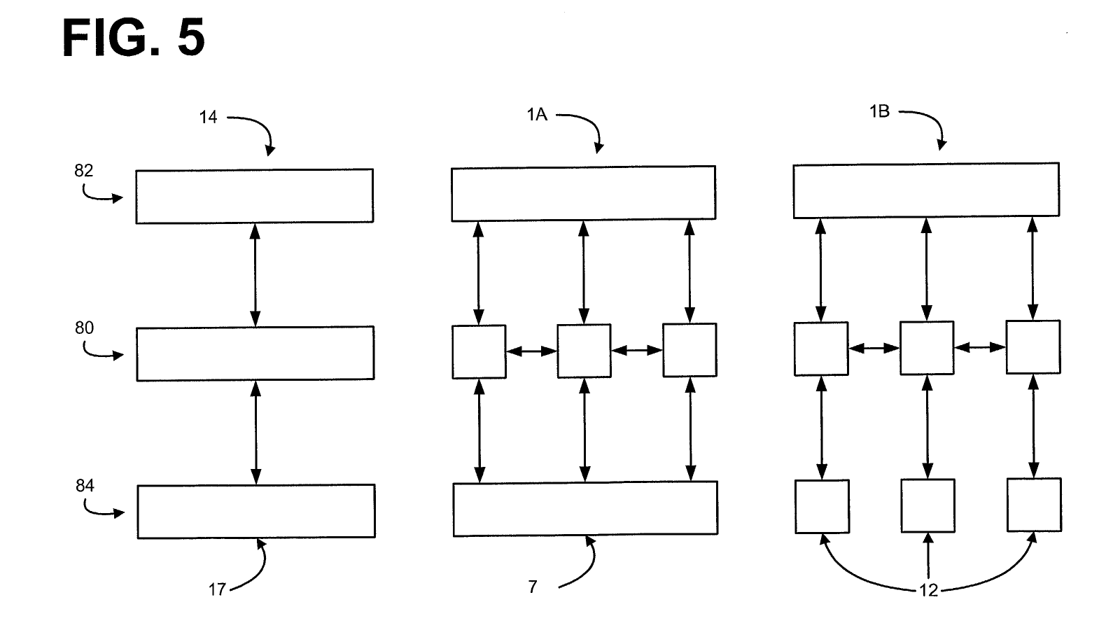

FIG. 5 shows schematic views of the composition of a known system, as well as of a first and a second embodiment of the customer care and billing system according to the invention.

FIG. 2 shows a schematic model of a first embodiment of the customer care and billing system 1 according to the invention. The database 7 in this system 1 solely serves to the permanent storage of data to make same accessible in the future. Application logic will take care of most of the functions of a database 17 in known systems 14. Corresponding to the offered customer care and billing services components 5 are constructed being able to communicate with each other via common interfaces, not having to use the database 7 as an interface. Thus, a faster exchange of information between the applications is facilitated. Due to the division of application logic from the database 7 a structure is received that is flexible, extendible and suited for processing of a big amount of data. Changes or extensions of the system 1 thereby can be carried out without a great programming effort. Thus the structure allows to solve each problem exactly only one time and to make the solution available for all components 5 of the system 1 in a simple manner. Simultaneously it is ensured for nearly each implemented solution that this solution does not only solve on dedicated problem, but always a category of problems.

For a better understanding of the term “component” as used herein, the following example of a division of the customer care services in components 5, regarding the telecommunication sector, is set. For example, a possible division of the system 1 provides the following components 5:

Risk management,

Fraud management,

Trouble ticket management,

Address management,

Accounts receivable,

Document management,

Task management,

Order management,

Product management and

Inventory management.

By use of the component “Risk management” the system user has the ability to check if customers are credit-worthy. The component “Fraud management” is used to the detection of frauds. For example, irregularities or big deviations from the usual customer behaviour are detected, like a big amount of international calls by a customer who has never before called to foreign countries. Within the component “Trouble ticket management” complaints by customers and fault indications of the cellular network itself are registered and handled. By use of the component “Address management” an address register is administered allowing a check of plausibility of an address. The component “Accounts receivable” is used for a kind of debt accounting. By use of this component payment deliveries and outstanding invoices are registered and accounts can be balanced. The component “Document management” is used for administration of customer documents (letters, faxes, etc.). The services of the component “Task management” are helpful for placing job instructions corresponding to incoming orders. The component “Order management” can be used for processing orders and for other customer care services. By use of the component “Product management” the consumer can get informed about the availability of products and about price lists. The component “Inventory management” is used for stock administration, i.e. by its use the administration of already taken or still available telephone numbers, SIM-cards or other articles is simplified. Each of the cited components offers a relatively large amount of services. As mentioned above the components 5 are able to exchange data via direct interfaces. For example, if component “Accounts receivable” needs specific customer data, it will not fall back on data from the database but it will obtain the necessary data directly from the component “Order management” or appropriate other components.

The component model for a customer care and billing system 1 requires that a basic functionality is available in a centralised framework 10. Each component 5 is independent from all other components. However, components are reliant on a set of services to operate correctly. These services can also be provided by third party components. On these conditions it is possible to integrate third party components in a system with components according to the invention.

However, the present system 1 is not formed as a pure service-based model, but also comprises some elements of a more object-oriented model. Detailed information on this subject will follow later on.

Lots of definitions of the term “component” exist in the area of object-oriented programming. The definition being closest to the components 5 deployed in the present customer care and billing system 1, as used in practice, is:

“A component is a unit of composition with contractually specified interfaces and (as possible) explicit context dependencies only. A software component can be deployed independently and is subject to composition by third parties.”

The key aspects of this definition are that a component 5 can be deployed and used independently from other components, that a component 5 can be used by other vendors to make customer care and billing systems, and that a component 5 contains interfaces only, i.e. it contains no state in the usual sense of a word, although a component 5 may have properties and places certain explicit demands on its use within a context.

The components 5 of the present system 1 usually are fairly large. This follows from the fact that a component 5 can be individually deployed within a certain context and must therefore be sufficiently self-contained. However, components 5 with only one interface are possible, too.

Component interfaces are primarily service-based. Given that a component 5 has no state, the interfaces provided by a component instance provide services and do not return information about the component state. The number of services or interfaces, respectively, provided by a component 5 must equal the number necessary to fully publish the set of behaviours encapsulated within the component 5.

As mentioned above, the present component model mainly uses services, especially to facilitate the use of components 5 with components of other vendors. On the other hand the present customer care and billing system 1 in addition uses a more traditional object-oriented model for the communication between components 5 of the system 1 according to the invention. Components 5 then publish their internal classes for use by other components, what is more in line with peer-to-peer system architectures.

In addition, the solution using peer-to-peer objects is used that allows clients to directly access and use the objects within a component, so that GUI developers can employ modern building tools based on a model view pattern.

Thus, the components 5 exist as logically singular units within a system. The technical base for execution and communication is provided by a framework 10. The framework 10 is part of the system 1 which is completed by adding business-specific logic. Details regarding the system architecture are explained with reference to FIG. 3.

Components 5 communicate with each other using published services, but also have context demands, i.e. all behaviour that a component 5 relies upon and that is not implemented in the component 5 itself can be from other components or from the framework. One of the main features of the framework concerns containment, i.e. the framework must provide the container for the execution of a component 5. In addition, the structure of the component design allows the easy packaging of application elements for containment purposes.

The structure of the component software is as follows: Business domain classes are grouped into packages, where a package is a fairly fine-grained logical domain. These packages are grouped into components 5, so that packages in a component 5 contain classes that use each other to a significant degree while packages in separate components 5 use each other as little as possible. Finally, components 5 are grouped together in servers. This grouping can be arbitrary, also it is advantageous when components 5 that communicate with each other often are deployed in the same server. For the use of components 5 according to the invention in another framework it is necessary to remove as many dependencies as possible between the execution environment and a component 5. Therefore each component 5 needs its own global AbstractFactory instance; this cannot be per server because it cannot be guaranteed that the component 5 will run within this server.

One of the main concepts in the framework that render the framework into a component framework is the AbstractComponent class. This class contains the attributes and behaviour that are common to all components 5. Specific components 5 are subclasses of this class. Since the services provided by a component 5 will be involved in transactions, and multiple component services can be involved in one transaction, the AbstractComponent class is transactional.

The subclasses of the AbstractComponent class, the actual components 5, contain all the services specific for the component 5. Another essential feature of each subclass is an instance of a facade class for each external component with which the component 5 communicates.

Services on the component boundaries, or those that are actually implemented in other components, are modeled internally using facade objects. The services in the facades are those, that the component 5 needs to function. For example, if component “A” uses interface in component “B” and “C”, then component “A” will have a “B” facade instance internally as well as a “C” facade instance. Design and implementation of component “A” can then be done largely independently of component “B” and “C”. When the components are customized for execution, the services in the facades must be mapped to appropriate services in other components.

In a preferred embodiment of the customer care and billing system 1 these facades are implemented in a way that the mapping of facade service to actual component service can be done without coding. For this reason there is an abstract class that holds generic behaviour, the AbstractFacade class. For both published domain objects and components 5 the framework 10 supports cross component transactions. Implicit propagation is used for component to component service invocation. Relating to the memory management sector transaction contexts are used for non-transaction related purposes.

Summing up it can be emphasised that the preferred embodiment of the customer care and billing system 1 uses services in component facades when providing services for external components. On the other hand components 5 publish their internal classes for use by other components 5 according to the invention.

FIG. 3 shows the division of the system 1 in hierarchically arranged layers with increasing degree of abstraction and in tiers corresponding to technical tasks. The layers and tiers of the system architecture provide a two-dimensional matrix. However, this division is not explicitly represented in the package structure of the framework 10.

Each layer is isolated from the complicated matters of the underlying layers, so that the communication between layers is implemented only via use of standard interfaces. Thus a high degree of flexibility and independence can be guaranteed.

In a preferred embodiment the system 1 is divided into five layers. The lowest base layer 40 contains classes comprising fundamental behaviour like system resources, operating system and hardware-specific classes. The layer also contains behaviour provided by applied third party software. In the preferred embodiment the basics of CORBA, a common standard architecture for object request brokers, as well as of TopLink, an object relational mapping facility, are contained. Java is used as programming language in this embodiment.

In the common layer 42 located above the base layer 40 abstractions of classes of the base layer 40 are contained as well as classes providing common facilities for all layers and tiers. Elements for logging and exception handling are also included.

The technical services layer 44 is located above, comprising classes that provide software-related technical services.

The application layer 46 located above comprises all classes and behaviour for a dynamic definition of elements of an application or of a component 5, respectively, on a meta-level. Instances of these classes are used in the interaction with a real application. The services of the technical services layer 44 combine to an abstract application, and mechanisms for description of the elements of the domain tier 58 on a meta-level are allowed. The application layer 46 comprises the classes that represent the highest level of abstraction in the system, for example the factory which uses multiple services from underlying layers, i.e. transaction and persistence support.

The combination of elements from the base layer 40 up to some parts of the application layer 46 can also be described as (technical) framework 10. By adding a business layer 50 which contains the specific classes for the behaviour of an application and a component 5, and in which the real service-specific processes are programmed, the system 1 is completed.

Due to the insulation of the single layers it is possible that, for example, the activities of a business logic developer are not influenced by changes in an underlying layer (for example changes of the operating system).

In addition, the system 1 can be divided into various tiers. It has to be distinguished between the division into logical and physical tiers. The division of the system into two logical tiers (thick clients) or three logical tiers (thin clients) provides the advantage that processes can be performed independently and simultaneously in different logical tiers. In the present preferred embodiment the system in addition is divided into a more fine-grained structure having physical tiers.

The highest tier, thus being next to the system user, is the presentation tier 52. Although the server is not concerned with the presentation tier 52, its framework 10 must provide some facilities with which presentation layer objects communicate, and additionally must dictate how presentation-specific behaviour must be handled. The elements of presentation relate to the representation of information, the navigation through this information and the manipulation thereof. The framework 10 of the server presupposes the use of an object-oriented user interface and provides facilities accordingly. The elements of the presentation layer 52 use the descriptive information provided in meta-application instances to define aspects of how business objects and their attributes should be viewed or used. This meta-application information provides a layer of insulation between the presentation objects (windows) and application or business objects. An additional layer of insulation can be given via access privilege schemes that reveal or hide server elements.

The application tier 54 comprises classes and interfaces representing the application, as well as classes that package application component behaviour. A number of classes is contained which are necessary for interaction with an application, as well as the fundamental abstract class for application control classes and application process classes. These classes are the primary interface for clients within the applications. They provide the fundamental mechanisms for communicating with the application, creating instances of desired objects, and allow navigation to these objects.

Summing up it can therefore be pointed out that the application tier 54 contains the classes which model business processes that use underlying business objects. Thus, the majority of customisation labour is isolated in this tier.

Further the application tier 54 contains facade objects which are the primary means of communication between components 5.

The classes in the meta-application tier 56 provide means for an application to describe and to change aspects of itself. The meta-application tier 56 consists of classes allowing the definition of information concerning aspects of application objects and domain objects. These classes make it possible to dynamically configure aspects of business objects on a meta-level. Such aspects include naming of classes, format masks and lengths for attributes and further information, whether or not certain attributes are mandatory etc.

The meta-application facilities are on a higher level than applications and provide generic functionality that is applicable to all applications.

The domain tier 58 contains business object classes for a specific application domain. In other words, the domain tier 58 is the tier which exclusively contains classes that model the business domain of an application. Thus, the development effort for application developers will mostly be concerned with this tier.

The domain tier 58 is almost exclusively composed of an abstract domain class from which all business objects inherit behaviour. In addition, the domain tier 58 contains domain classes that are subclasses of the abstract class above. These classes model stable non-changing behaviour of the central classes of a problem domain. All volatile behaviour that concerns a domain class is encapsulated in classes that are pushed into the application tier 54, but are used by the domain classes.

The persistence tier 60 is the tier that encapsulates the interaction between domain objects and a persistent store. Thus, it contains the behaviour that provides persistence for objects, their storage and retrieval. This tier also contains the class which manages the connection with the database 7. The persistence tier 60 represents a reproduction of the class model of the domain tier 58 into the data model of the database 7 and supports mechanisms for transaction-protected manipulation of data in the database 7.

The functionality of the database tier 62 has already been described above.

The different possibilities of variation on server side or client side, respectively, resulting in changes or extensions of the system 1 can be described best making reference to the scheme in FIG. 4. Based on the framework 10 client side 70 and server side 71 are shown separately. On server side 71, the business layer objects 72, application layer objects 74 and meta-application layer objects 76 are depicted. On client side 70, the necessary interfaces 66, especially GUI's, are shown as well as specific JavaBeans 68. Arrows sketch the possibilities of interaction between client and server or within the client, respectively.

The specific JavaBeans 68 are able to create prefabricated GUI-facilities on client side 70, so that the system user can execute his settings by use of user interfaces. Therefore, it is possible to make the server's interface model available on client side 70 and to hide the employed communication technology from a client developer. Thus, interfaces are provided to the system user to implement his demands. That happens at specific localised spots, so that no basic codes have to be changed.

A very useful means for reaching this goal is the meta-application dictionary. It contains a big amount of information about an application, its classes and the attributes in these classes. Therefore, the meta-application dictionary allows a dynamic configuration of application information and processing on a meta-level. The actual dictionary is represented by an instance, which functions as the root of the dictionary and in addition contains information about the application as an application. It also contains the set of instances that define meta-information for classes.

Due to the meta-application dictionary a lot of properties are fixed being valid for each class in the server. Thus, an extension or change of behaviour of the whole system 1 can be employed during processing without coding. These extensions are implemented by deriving from the business classes included in the server and/or by adding new classes. The new classes are configured into the server by using meta-application facilities of the server. These subclasses can substitute most of the existing methods and have the ability to change or extend the existing functionality.

FIG. 5 shows a schematic view of the evolution from known systems 14 to a first and a second embodiment of the customer care and billing system 1 according to the invention. The division of the systems into three logical tiers for presentation logic 82, application logic 80 and database 84 representing the basis of FIG. 5 can only be regarded as background for the above-described division of the customer care and billing system I according to the invention into physical tiers which provides preferably more than three tiers as mentioned above.

Regarding known systems 14, presentation logic 82, application logic 80 and database 17 each are building a big block with appropriate communication facilities which have been explained in detail in the description of FIG. 1. In the system 1 according to the invention, it is not only possible to separate the application logic 80 corresponding to the offered services, but it is also conceivable that the database 7 itself will be divided into logically separated database sections 12 instead of building a big monolithic block and/or that multiple separated database 12 exist. Each database section and/or each separated database 12 is relevant for storage and retrieval of data of only one component 5.

By use of the present customer care and billing system I it is possible to reproduce additional application servers corresponding to existing servers for parallel use.

Thus, the customer care and billing system 1 is suited for system users having millions of customers and a big amount of transactions.

Furthermore, the system 1 provides mechanisms to facilitate a transaction and memory management distributed over components 5.

The above described preferred model of the customer care and billing system 1 is only one preferred embodiment while many variations of this specific embodiment can be imagined. For example, the number of layers or tiers can differ from that defined by the above-described model, as long as the division into at least two layers and at least two tiers is kept. The system 1 can be used with thin or thick clients. The explicit division of the system 1 into real components 5 which has been explained with reference to FIG. 1 is also an example. Thus, other services of the customer care and billing sector can be combined to an appropriate component 5 as long as the generic criteria for a component 5 are fulfilled. The use of Java, CORBA and TopLink is also a question of the current supply in the market. It is, of course, possible to use other products having similar properties to fulfill the same tasks.

In particular, it should be noted that the use of the customer care and billing system 1 is not limited to the telecommunication sector. Rather it is possible to use the system 1 in the whole consumer industry (power supply, water supply, gas supply, internet, etc.) or to use customer care parts of the system 1 for pure customer administration in firms, respectively.

1. Customer care and billing system (1), especially for communication services, comprising:
At least one database (7) for storage and retrieval of data preferably formed as a server,
a plurality of clients communicating with the at least one database (7), and/or at least one application server with accompanying clients, the server communicating with the at least one database (7), and
an appropriate framework (10),
wherein relevant services corresponding to desired customer care or billing processes are offered to the system user, characterised in that
the system (1) comprises a distributed component architecture including components (5) attributed in correspondence to the relevant services offered, wherein the components (5) are able to communicate with each other directly via interfaces.

2. Customer care and billing system (1) according to claim 1, characterised in that the system (1) is divided into at least two hierarchically arranged layers with increasing degree of abstraction wherein any lower layer isolates the above layer from the lower layers so that details of implementations of the lower layers are hidden from the layers above.

3. Customer care and billing system (1) according to claim 1 or 2, characterised in that the system (1) is divided into at least two hierarchically arranged tiers corresponding to technical tasks wherein the combined elements of all tiers together completely fulfill the tasks from the storage to the presentation of data.

4. Customer care and billing system (1) according to one of claims 1 to 3, characterised in that the system (1) comprises a lowest base layer (40) containing fundamental system behaviour.

5. Customer care and billing system (1) according to one of claims 1 to 4, characterised in that the system (1) comprises a common layer (42) located above the base layer (40) containing abstractions of classes of the base layer (40) and classes that provide common facilities for all layers and tiers.

6. Customer care and billing system (1) according to one of claims 1 to 5, characterised in that the system (1) comprises a technical services layer (44) located above the common layer (42) providing software-related technical services.

7. Customer care and billing system (1) according to one of claims 1 to 6, characterised in that the system (1) comprises an application layer (46) located above the technical services layer (44) combining the services of the technical services layer (44) in an abstract application and allowing mechanisms for description of the elements of the domain tier (58) on a meta-level.

8. Customer care and billing system (1) according to one of claims 1 to 7, characterised in that the system (1) comprises a business layer (50) located above the application layer (46) containing the domain-specific classes for each component (5).

9. Customer care and billing system (1) according to one of claims 1 to 8, characterised in that the system (1) comprises a presentation tier (52) implementing the presentation of data and the feasibilities of application for the user of the system (1).

10. Customer care and billing system (1) according to one of claims 1 to 9, characterised in that the system (1) comprises an application tier (54) containing classes and interfaces that represent the application.

11. Customer care and billing system (1) according to one of claims 1 to 12, characterised in that the system (1) comprises a meta-application tier (56) containing classes that provide facilities to an application to describe aspects of itself.

12. Customer care and billing system (1) according to one of claims 1 to 11, characterised in that the system (1) comprises a domain tier (58) containing business object classes of a specific application domain.

13. Customer care and billing system (1) according to one of claims 1 to 12, characterised in that the system (1) comprises a persistence tier (60) representing a reproduction of the class model of the domain tier (58) into the data model of the at least one database (7) and supporting mechanisms for transaction-protected manipulation of data in the at least one database (7).

14. Customer care and billing system (1) according to one of claims 1 to 13, characterised in that the system (1) comprises a meta-application dictionary containing information about one component (5), its classes and the attributes of these classes, and allowing the dynamic configuration of application information and processing on a meta-level.

15. Customer care and billing system (1) according to one of claims 1 to 14, characterised in that the system (1) comprises facilities (68) to make the server's interface model available on client side (70) and thus to hide the employed communication technology from a client developer.

16. Customer care and billing system (1) according to one of claims 1 to 15, characterised in that the system (1) provides defined interfaces and mechanisms for inquiry distribution, so that multiple application server of the same kind can be added to the system (1).

17. Customer care and billing system (1) according to one of claims 1 to 16, characterised in that the system (1) provides the possibility of replacing or adding components (5).

18. Customer care and billing system (1) according to one of claims 1 to 17, characterised in that classes can be extended and/or new classes can be added to vary a component during processing by using meta-application facilities.

19. Customer care and billing system (1) according to one of claims 1 to 18, characterised in that the database (7) comprises a plurality of independent database sections (12) and/or multiple independent databases (12) exist, wherein each of the independent database sections and/or the independent databases (12) only communicate with one component (5).

20. Customer care and billing system (1) according to one of claims 1 to 19, characterised in that the system (1) provides mechanisms to allow transaction and memory management distributed over components (5).
